(19) United States
(12) Patent Application Publication
(10) Pub. No.: US 2026/0088398 A1
(43) Pub. Date: Mar. 26, 2026

(54) EXTERIOR MATERIAL MANUFACTURING METHOD FOR LITHIUM SECONDARY BATTERY, MANUFACTURING METHOD FOR LITHIUM SECONDARY BATTERY, EXTERIOR MATERIAL MANUFACTURING DEVICE FOR LITHIUM SECONDARY BATTERY, AND LITHIUM SECONDARY BATTERY

(71) Applicant: SK ON CO., LTD., Seoul (KR)

(72) Inventors: Ji Hyung KIM, Daejeon (KR); Young Ha KIM, Daejeon (KR); Sang Bin LEE, Daejeon (KR); Ho Jin HWANG, Daejeon (KR)

(21) Appl. No.: 19/162,058

(22) PCT Filed: Jan. 3, 2024
(86) PCT No.: PCT/KR2024/000134

§ 371 Date: Sep. 4, 2025

(30) Foreign Application Priority Data
Mar. 8, 2023 (KR) 10-2023-0030646

(51) Int. Cl. H01M 50/103; H01M 10/04; H01M 10/0525; H01M 50/133; H01M 50/184; H01M 50/531

(52) U.S. Cl. CPC H01M 50/103; H01M 10/0404; H01M 10/0525; H01M 50/133; H01M 50/184; H01M 50/531

(57) ABSTRACT

A method for manufacturing an outer shell for a lithium secondary battery according to an embodiment of present disclosure comprising: (a) a step of preparing an electrode assembly mold and the outer shell; (b) a step of wrapping the electrode assembly mold with the outer shell and grapping a portion of the outer shell; and (c) a step of pulling a part of the outer shell grabbed in the step (b) and adjoining the electrode assembly mold and the outer shell.

### CROSS-REFERENCE TO RELATED APPLICATION(S)

This application is a national stage application of PCT/KR2024/000134 filed on Jan. 3, 2024, which claims priority of Korean patent application number 10-2023-0030646 filed on Mar. 8, 2023. The disclosure of each of the foregoing applications is incorporated herein by reference in its entirety.

### FIELD

The present disclosure relates to a method for manufacturing an outer shell for a lithium secondary battery, a device for manufacturing an outer shell for a lithium secondary battery, and a lithium secondary battery.

### BACKGROUND TECHNOLOGY

With the development of the electronics, communication, and space industries, the demand for lithium secondary batteries as an energy power source is increasing. In particular, the electric vehicle market is growing by leaps and bounds as the importance of global eco-friendly policies is emphasized, and research and development on lithium secondary batteries is being actively conducted both domestically and internationally.

Lithium secondary batteries can be categorized into cylindrical batteries, prismatic batteries, and pouch batteries depending on their shape. Pouch-type batteries can be preferred over other shaped batteries because they can secure sufficient energy density.

In manufacturing a pouch-type cell, a process may be performed to form a pouch-type shell such that the pouch-type shell has a shape suitable for accommodating an electrode assembly. For example, the pouch-type shell may be formed by a forming punch pushing through a center region of the pouch-type shell while both ends of the pouch-type shell are clamped.

However, if the forming punch pushes the pouch shell in one direction, at least a portion of the pouch shell may be stretched in the direction in which it is pushed, causing physical damage such as cracks in the stretched region. In this case, the stability and reliability of the battery may be questionable.

Therefore, there is a need for research on process products and process methods that ensure stability of the physical structure of the pouch-type outer shell.

### DETAILED DESCRIPTION OF THE INVENTION

### Technical Challenges

Embodiments of the present disclosure provide a method for manufacturing an outer shell for a lithium secondary battery, a method for manufacturing a lithium secondary battery, a device for manufacturing an outer shell for a lithium secondary battery, and a lithium secondary battery in which a sufficient number of electrode cells can be applied so that a high energy density can be obtained. Further, physical defects of the outer shell may be prevented so that the battery stability is improved.

### Technical Workaround

A method for manufacturing an outer shell for a lithium secondary battery according to an embodiment of the present disclosure may comprise: (a) a step of preparing an electrode assembly mold and the outer shell; (b) a step of wrapping the electrode assembly mold with the outer shell and grapping a portion of the outer shell; and (c) a step of pulling a part of the outer shell grabbed in the step (b) and adjoining the electrode assembly mold and the outer shell.

In an embodiment, a shape of the electrode assembly mold may correspond to a shape of the electrode assembly to be accommodated in the outer shell.

In an embodiment, a thickness of the electrode assembly mold may correspond to a thickness of the electrode assembly to be accommodated in the outer shell.

In an embodiment, the step (b) may include a step of exposing both ends of the electrode assembly mold and a step of surrounding the outer surface of the electrode assembly mold by the outer shell.

In an embodiment, the step (c) may include a step of contacting the outer shell into with the electrode assembly mold so that the region surrounded by the outer shell has the same shape as the electrode assembly mold.

In an embodiment, the step (c) may include a step of deforming the shape of the outer shell without pushing one side of the outer shell.

In an embodiment, the step (c) may further include a step of forming each edge of the outer shell adjacent to the electrode assembly mold in the step (c).

In an embodiment, the method may further comprise a step of forming a part of the outer shell between a pulling unit for pulling a part of the outer shell and the electrode assembly mold.

A method for manufacturing a lithium secondary battery according to another embodiment of the present disclosure may comprise: (a) a step of preparing an electrode assembly mold and the outer shell; (b) a step of wrapping the electrode assembly mold with the outer shell and grapping a portion of the outer shell; (c) a step of pulling a part of the outer shell grabbed in the step (b) and adjoining the electrode assembly mold and the outer shell; (d) a step of forming each edge of the outer shell adjacent to the electrode assembly mold in the step (c); and (e) a step of removing the electrode assembly mold and accommodating the electrode assembly in the outer shell after the step (d).

In another embodiment, a thickness of the electrode assembly mold may be substantially the same as a thickness of the electrode assembly to be accommodated in the outer shell, and wherein a shape of the electrode assembly mold is substantially the same as a shape of the electrode assembly to be accommodated in the outer shell.

In another embodiment, the step (b) may include a step of exposing both ends of the electrode assembly mold by the outer shell and a step of surrounding the outer surface of the electrode assembly mold by the outer shell.

In another embodiment, the step (c) may include a step of deforming the shape of the outer shell without pushing one side of the outer shell.

A device for manufacturing an outer shell for a lithium secondary battery according to another embodiment of the present disclosure may comprise: an electrode assembly mold having the same shape as an electrode assembly; and a pulling unit disposed on one side of the electrode assembly mold, grapping an end of a pouch-shaped outer shell for accommodating the electrode assembly, and pulling the end of the pouch-shaped outer shell.

In another embodiment, the device may further comprise: a forming portion to push at least a part of the pouch-shaped outer shell.

In another embodiment, a thickness of the electrode assembly mold may be substantially the same as a thickness of the electrode assembly to be accommodated in the outer shell, and wherein a shape of the electrode assembly mold may be substantially the same as a shape of the electrode assembly to be accommodated in the outer shell.

A lithium secondary battery according to another embodiment of the present disclosure may comprise: an outer shell; and an electrode assembly accommodated in the outer shell and including an electrode cell including a positive electrode, a negative electrode, and a separator; wherein the outer shell may include an upper surface, a lower surface, and a side surface, and wherein a thickness of the outer shell on the side surface may be 0.8 times or more and 1.0 times or less than a thickness of the outer shell on the upper surface.

In another embodiment, the lithium secondary battery may further comprise: a positive tab electrically connected to the positive electrode, and a negative tab electrically connected to the negative electrode, wherein the outer shell may include a pouch sealing portion, wherein the pouch sealing portion may include side sealing portions arranged adjacent to the positive tab or the negative tab and a body sealing portion arranged between the side sealing portions, and wherein the side surface may include a one side surface adjacent to the body sealing portion and a second side surface adjacent to the side sealing portions.

In another embodiment, the thickness of the outer shell on the side surface may be 0.9 times or more and 1.0 times or less than the thickness of the outer shell on the upper surface.

### Effect

According to an embodiment of the present disclosure, a method for manufacturing an outer shell for a lithium secondary battery, a method for manufacturing a lithium secondary battery, a device for manufacturing an outer shell for a lithium secondary battery, and a lithium secondary battery are provided in which a sufficient number of electrode cells can be applied so that a high energy density can be obtained. Further, physical defects of the outer shell may be prevented so that the battery stability is improved.

### DESCRIPTION OF THE DRAWING

FIG. 1 is a schematic perspective view illustrating a lithium secondary battery according to an embodiment.

FIG. 2 is a schematic plan view illustrating a lithium secondary battery according to an embodiment.

FIGS. 3 and 4 are schematic cross-sectional views illustrating a lithium secondary battery according to embodiments.

FIGS. 5 to 17 are schematic drawings illustrating a manufacturing method for a lithium secondary battery according to an embodiment.

### EMBODIMENTS

Certain structural and functional descriptions of embodiments in accordance with the concepts of the present disclosure disclosed in this specification or application are illustrated for the purpose of describing embodiments in accordance with the concepts of the present disclosure only, and should not be construed as limiting the embodiments described in this specification or application, as embodiments in accordance with the concepts of the present disclosure may be practiced in various forms.

Hereinafter, with reference to the accompanying drawings, a method for manufacturing an outer shell for a lithium-ion battery, a method for manufacturing a lithium-ion battery, and an apparatus for manufacturing an outer shell for a lithium-ion battery will be described in accordance with embodiments.

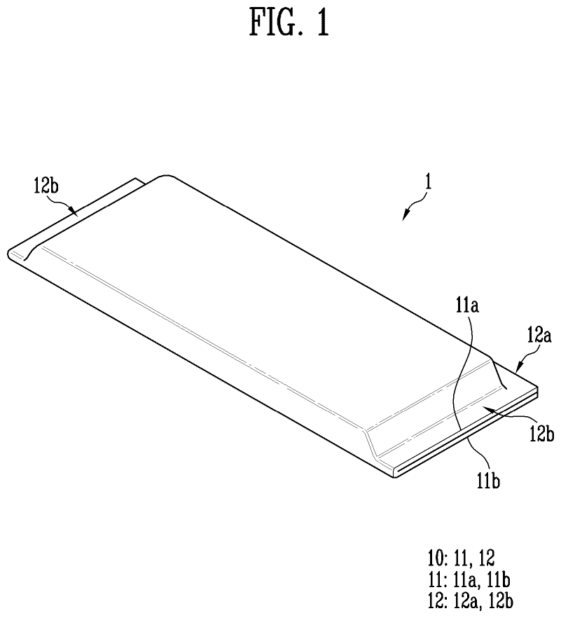

First, a lithium secondary battery 1 according to an embodiment will be described with reference to FIGS. 1 to 4.

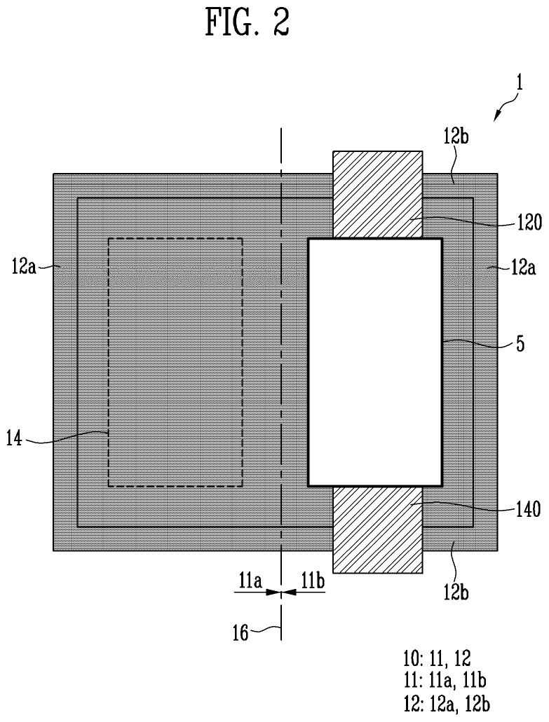

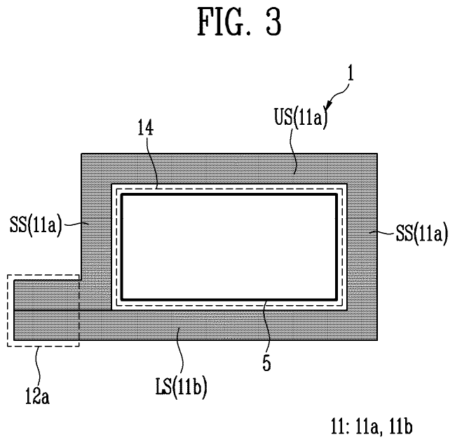

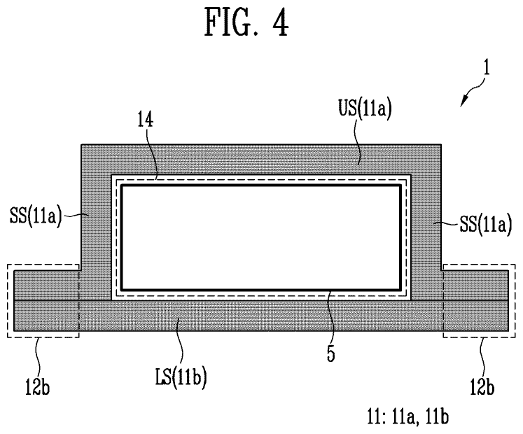

FIG. 1 is a schematic perspective view illustrating a lithium secondary battery according to an embodiment. FIG. 2 is a schematic plan view illustrating a lithium secondary battery according to an embodiment. FIGS. 3 and 4 are schematic cross-sectional views illustrating a lithium secondary battery according to embodiments.

Referring to FIGS. 1 to 4, the lithium secondary battery 1 may be a pouch-type secondary battery. The lithium secondary battery 1 includes an outer shell 10 for a lithium secondary battery and an electrode assembly 5 accommodated within the outer shell 10 of the lithium secondary battery. Depending on the embodiment, the lithium secondary battery 1 may further include a positive tab 120 and a negative tab 140.

Hereinafter, for ease of description, the outer shell 10 for the lithium secondary battery is referred to as the “outer shell”.

The outer shell 10 can include a variety of materials. For example, the outer shell 10 may be a pouch-shaped film including an aluminum layer and a polypropylene layer. However, the present disclosure is not necessarily limited to this particular example.

The outer shell 10 may include a pouch film 11 and a pouch sealing portion 12 formed on the periphery of the pouch film 11. The pouch film 11 may include a first pouch film 11a and a second pouch film 11b formed integrally with each other.

The first pouch film 11a and the second pouch film 11b may be separated based on a separation line 16. The first pouch film 11a and the second pouch film 11b may abut at one end of the outer shell 10, and may form a pouch sealing portion 12 that separates the space 14 from the outside.

The first pouch film 11a and the second pouch film 11b can be opposed to each other, and form the space 14 in which the electrode assembly 5 is accommodated. The space 14 may also be referred to as the forming portion.

According to an embodiment, the space 14 may be formed as a portion of the first pouch film 11a is indented, or according to an embodiment, the space 14 may be formed as a portion of the second pouch film 11b is indented, or according to an embodiment, the space 14 may be formed as at least a portion of the first pouch film 11a and the second pouch film 11b is indented, or according to an embodiment, the space 14 may be formed as at least a portion of each of the first pouch film 11a and the second pouch film 11b is indented. For ease of explanation, the following discussion will refer to an embodiment in which the first pouch film 11a forms the space 14.

The size of the space 14 may correspond to the size of the electrode assembly 5. For example, the height of the space 14 may be substantially equal to a thickness of the electrode assembly 5. In other words, the size of the space 14 may be determined by the size of the electrode assembly 5.

According to an embodiment, the physical stability of the outer shell 10 may be ensured during the manufacturing process, such that the outer shell 10 may be manufactured such that the space 14 has a sufficient height. In other words, the thickness of the electrode assembly 5 may be freely selectable depending on the user's intention and the energy density of the lithium secondary battery 1 to be manufactured. More details on this will be described later.

According to an embodiment, the pouch sealing portion 12 may include a body sealing portion 12a adjacent to the region between the positive tab 120 and the negative tab 140, and side sealing portions 12b adjacent to the positive tab 120 and the negative tab 140. The body sealing portion 12a may be arranged between the side sealing portion 12b corresponding to the positive tab 120 and the side sealing portion 12b corresponding to the negative tab 140.

According to an embodiment, the outer shell 10 may be manufactured to include a space 14 for accommodating the electrode assembly 5. When performing the process for forming the space 14 in the outer shell 10, the pouch film for manufacturing the outer shell 10 may not be overstretched. Accordingly, the thickness of the outer shell 10 according to embodiments may be substantially uniform. In accordance with embodiments, the thickness of the outer shell 10 at one location and the thickness of the outer shell 10 at another location may be substantially the same. Accordingly, the insulation performance and resistance variation of the outer shell 10 according to embodiments may be substantially uniform from location to location.

According to an embodiment, the outer shell 10 may include an upper surface US, a lower surface LS, and a side surface SS. For example, the first pouch film 11a may include an upper surface US and a side surface SS, and the second pouch film 11b may include a lower surface LS. The side surface SS may include a firsts side surface adjacent to the body sealing portion 12a and a second side surface adjacent to the side sealing portion 12b.

According to an embodiment, the side surface SS may refer to an outer surface of the outer shell 10 along a thickness direction of the electrode assembly 5 or a height direction of the lithium secondary battery 1. The upper surface US and the lower surface LS may refer to the outer surface of the outer shell 10 along the region direction of the electrode assembly 5 or the lithium secondary battery 1.

Depending on the embodiment, the thickness of the outer shell 10 at the upper surface US, the thickness of the outer shell 10 at the lower surface LS, and the thickness of the outer shell 10 at the side surface SS may differ from each other or may correspond to each other by a predetermined difference or less.

For example, the thickness of the outer shell 10 at the side surface SS may be 0.8 times or more and 1.0 times or less than the thickness of the outer shell 10 at the upper surface US. The thickness of the outer shell 10 at the side surface SS can be 0.8 times or more and 1.0 times or less than the thickness of the outer shell 10 at the lower surface LS. In another example, the thickness of the outer shell 10 at the side surface SS may be 0.9 times or more and 1.0 times or less than the thickness of the outer shell 10 at the upper surface US. The thickness of the outer shell 10 at the side surface SS may be 0.9 times or more and 1.0 times or less than the thickness of the outer shell 10 at the lower surface LS.

Experimentally, excessive stretching of the pouch film to form the space 14 may result in excessive thinning of the thickness of the pouch film at locations relative to the side surface SS. For example, in the prior art, the thickness of the thinned pouch film may be 0.5 times or less than the thickness of the initial pouch film as the pouch film is stretched. In this case, the durability of the lithium secondary battery 1 may be impaired, and the pouch film may not have sufficient insulating properties. However, the outer shell 10 according to the embodiment may not be subjected to substantially excessive stretching during manufacturing, and thus may have the structural features described above and may not be subject to the risks described above. Methods for manufacturing the outer shell 10 in this regard will be described later.

The electrode assembly 5 includes one or more electrode cells. The electrode cells include a positive electrode, a negative electrode, and a separator interposed between the positive electrode and the negative electrode. The electrode assembly 5 may be provided with an electrolyte. The electrode assembly 5 may be fabricated by winding, lamination, or folding of electrode cells. In accordance with embodiments, the electrode assembly 5 may have a jelly-roll type structure. However, the shape of the electrode assembly 5 is not particularly limited.

The positive electrode and negative electrode may each include a current collector formed of a plate and an active material layer disposed on the current collector. For example, the positive electrode may include a positive electrode collector and a positive electrode active material layer on the positive electrode collector, and the negative electrode may include a negative electrode collector and a negative electrode active material layer on the negative electrode collector.

The collector may include any conductive additive known in the art to the extent that it does not cause a chemical reaction within the lithium secondary battery 1. For example, the collector may include one or more of the group consisting of stainless steel, nickel, aluminum, titanium, copper, and alloys thereof, and may be provided in various forms, such as film, sheet, or foil.

The active material layer includes an active material. For example, a positive electrode active layer may include a positive electrode active material and a negative electrode active layer may include a negative electrode active material.

The positive electrode active material may be a material into which lithium ions can be inserted and delocalized. The positive electrode active material may be a lithium metal oxide. For example, the positive electrode active material may be one of a lithium manganese oxide, a lithium nickel oxide, a lithium cobalt oxide, a lithium nickel manganese oxide, a lithium nickel cobalt manganese oxide, a lithium nickel cobalt aluminum oxide, a lithium iron phosphate compound, a lithium manganese phosphate compound, a lithium cobalt phosphate compound, or a lithium vanadium phosphate compound. However, the present disclosure is not necessarily limited to the foregoing examples.

The negative electrode active material may be any material capable of absorbing and desorbing lithium ions. For example, the negative electrode active material can be any one of crystalline carbon, amorphous carbon, carbon composites, carbon-based materials such as carbon fibers, lithium alloys, silicon, and tin. In accordance with embodiments, the negative electrode active material may be natural or artificial graphite, but is not limited to any particular example.

The positive electrode and negative electrode may further include a binder and a conductive additive, respectively.

The binder may mediate the bonding between the collector and the active material layer, thereby improving mechanical stability. According to embodiments, the binder may be an organic binder or an aqueous binder, and may be used in conjunction with a thickener such as carboxymethyl cellulose. According to an embodiment, the organic binder is a vinylidene fluoride de-hexafluoropropylene copolymer, polyvinylidene fluoride, polyacrylonitrile, and polymethylmethancrylate, and the aqueous binder may be a styrene-butadiene rubber, but the present disclosure is not necessarily limited thereto.

The conductive additive may improve the electrical conductivity of the lithium secondary battery 1. The conductive additive may include a metal-based material. According to an embodiment, the conductive additive may include a conventional carbon-based conductive additive. For example, the conductive additive may include any one of graphite, carbon black, graphene, and carbon nanotubes. Preferably, the conductive additive may include carbon nanotubes.

A separator may be disposed between the positive electrode and the negative electrode. The separator may be configured to prevent an electrical short between the positive electrode and negative electrode, and to allow the flow of ions to occur.

The separator may include a porous polymeric film or a porous nonwoven fabric. The porous polymeric film may include a single layer or multiple layers including polyolefin-based polymers such as ethylene polymers, propylene polymers, ethylene/butene copolymers, ethylene/hexene copolymers, and ethylene/methacrylate copolymers. The porous nonwoven fabric may include high melting point glass fibers, polyethylene terephthalate fibers, and the like. However, without limitation, the separator may be a ceramic coated separator (CCS) including ceramic, according to an embodiment.

Meanwhile, the positive electrode may be electrically connected with the positive tab 120, and may be electrically connected via the positive tab 120 to a positive electrode lead of a conductive additive. In accordance with embodiments, the negative electrode may be electrically connected with the negative tab 140, and may be electrically connected to a negative electrode lead of a conductive additive via the negative tab 140. The positive electrode lead and negative electrode lead electrically connected with the positive tab 120 and the negative tab 140 may function as electrode interfaces to electrically connect the lithium secondary battery 1 and an external device to each other.

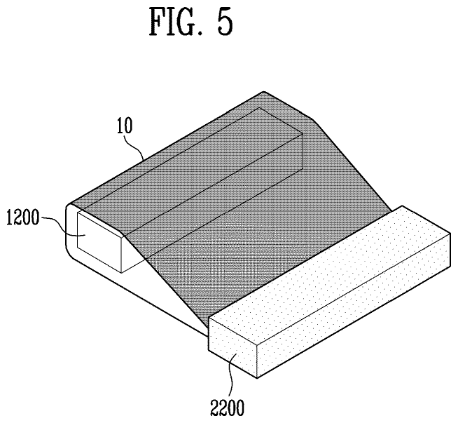

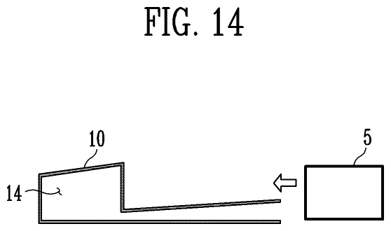

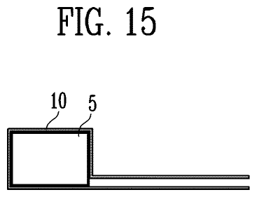

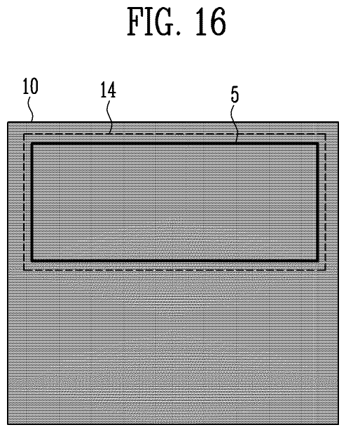

Hereinafter, with reference to FIGS. 5 to 17, a manufacturing method for an outer shell for a lithium secondary battery, a manufacturing method for a lithium secondary battery, and a manufacturing device for an outer shell for a lithium secondary battery will be described in accordance with an embodiment.

FIGS. 5 to 17 are schematic drawings illustrating a manufacturing method for a lithium secondary battery according to an embodiment.

FIGS. 5 to 8 and FIGS. 10 to 12 are illustrations of a method for manufacturing a shell 10 for a lithium-ion battery, which may be some steps of a method for manufacturing other lithium-ion batteries in an embodiment. FIGS. 5 to 8 and FIGS. 10 to 13 illustrate processes for manufacturing an outer shell 10 for a lithium-ion battery using a manufacturing device for manufacturing an outer shell 10 for a lithium-ion battery.

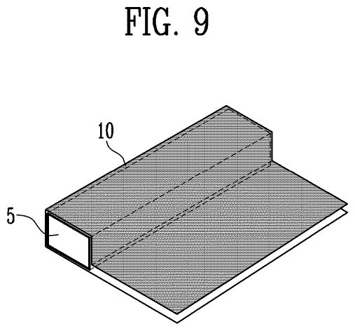

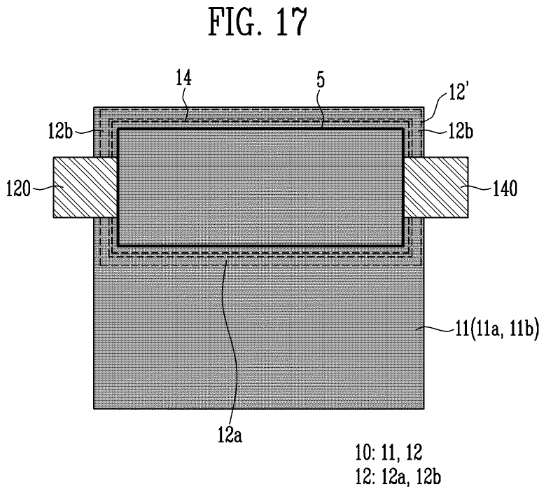

FIGS. 9, 14 to 16 illustrate a process step in which an electrode assembly 5 is accommodated within the shell 10 for a lithium-ion battery. FIG. 17 illustrates a process step in which a pouch sealing portion 12 is formed in the shell 10 for the lithium-ion battery.

According to an embodiment, to manufacture the lithium-ion battery shell 10, a lithium-ion battery shell manufacturing device is utilized. Hereinafter, the manufacturing device for manufacturing the outer shell for the lithium-ion battery will be referred to as the “outer shell manufacturing device” for convenience of description.

The device for manufacturing the shell includes an electrode assembly mold 1200 and a pulling unit 2200. The pulling unit 2200 may be disposed on one side of the electrode assembly mold 1200 and configured to deform the shape of the outer shell 10.

The outer shell manufacturing device may further include a forming portion, including a first forming portion 2400 and a second forming portion 2600.

The electrode assembly mold 1200 may be a member for forming a space 14 within the outer shell 10 to correspond to the shape of the electrode assembly 5.

For example, the electrode assembly mold 1200 may have a shape that corresponds to a shape of the electrode assembly 5 for being accommodated within the outer shell 10. The electrode assembly mold 1200 can have a volume that corresponds to a volume of the electrode assembly 5 for accommodating within the outer shell 10. The electrode assembly mold 1200 can have a thickness substantially equal to the thickness of the electrode assembly 5 for accommodating within the outer shell 10.

According to an embodiment, the electrode assembly mold 1200 may have a hexahedral shape similar to the electrode assembly 5, but this disclosure is not limited to any particular example.

The pulling unit 2200 can grab a portion of the outer shell 10, e.g., an end of the outer shell 10. For example, the pulling unit 2200 may be configured to press down on a portion of the outer shell 10, and may hold the portion of the outer shell 10 in place.

The pulling unit 2200 can pull a portion of the grabbed outer shell 10. For example, after grapping a portion of the outer shell 10, the pulling unit 2200 can pull the outer shell 10 from the electrode assembly mold 1200 in a direction facing the pulling unit 2200. Depending on the embodiment, the position of at least a portion of the pulling unit 2200 may change, but the manner in which the pulling unit 2200 operates is not limited to any particular example.

A plurality of first forming portions 2400 and second forming portions 2600 may be provided for pressing a portion of the outer shell 10. The first forming portion 2400 may be a member for pressing a portion of the outer shell 10 adjacent to a region in which the electrode assembly 5 is accommodated. The second forming portion 2600 may be a member for pressing against a corner region of a portion of the outer shell 10 that accommodates the electrode assembly 5.

In the following, individual steps of a method for manufacturing the outer shell 10 and a method for manufacturing the lithium secondary battery 1 including the outer shell 10 will be described.

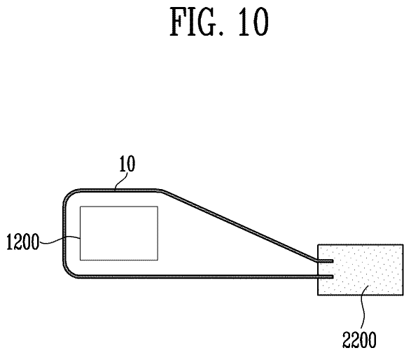

Referring to FIGS. 5 and 10, an electrode assembly mold 1200, an outer shell 10, and a pulling unit 2200 may be prepared. The outer shell 10 can wrap around the electrode assembly mold 1200. And an end of the outer shell 10 may be grabbed by the pulling unit 2200.

In this step, the outer shell 10 may expose both ends of the electrode assembly mold 1200, and may surround the outer surface of the electrode assembly mold 1200. Accordingly, the outer shell 10 can enclose the space in which the electrode assembly mold 1200 is disposed. According to an embodiment, the exposed both ends of the electrode assembly mold 1200 may correspond to the locations of the positive tab 120 and negative tab 140 of the lithium secondary battery 1 to be manufactured.

According to an embodiment, the outer shell 10 may expose both ends of the electrode assembly mold 1200, but may extend further outwardly from the both ends. For example, the separation distance between the both ends of the electrode assembly mold 1200 may be less than the length of the outer shell 10 in the same direction. Accordingly, a space 14 corresponding to the electrode assembly mold 1200 may be suitably formed in some regions of the outer shell 10 as subsequent processes are performed.

At this stage, the pulling unit 2200 may grab a first end of the outer shell 10, such that the outer shell 10 may be arranged to enclose the electrode assembly mold 1200.

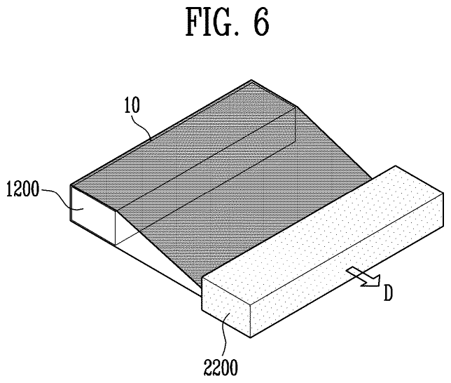

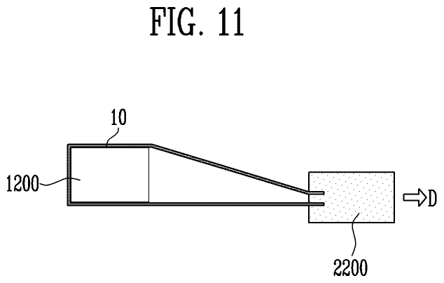

Referring to FIGS. 6 and 11, the pulling unit 2200 may pull the ends of the grabbed outer shell 10, such that the outer shell 10 surrounding the electrode assembly mold 1200 may be adjacent to the electrode assembly mold 1200.

In this step, the pulling unit 2200 may pull the ends of the outer shell 10 in a pulling direction D away from the electrode assembly mold 1200.

In this step, the outer shell 10 wrapping the electrode assembly mold 1200 can have a shape that corresponds to the shape of the electrode assembly mold 1200. For example, the outer shell 10 can be directly adjacent to the electrode assembly mold 1200 and can be in contact with the electrode assembly mold 1200. Accordingly, the shape of the outer shell 10 can be modified to have substantially the same as the outer surface of the electrode assembly mold 1200.

According to embodiments, to form the outer shell 10, one side of the outer shell 10 may not be pushed through a forming punch. Experimentally, when forming the outer shell 10 by pushing one side of the outer shell 10, e.g., a center region, etc., with a forming punch, at least a portion of the outer shell 10 may be physically damaged as some regions of the outer shell 10 along the direction of the pushing of the forming punch may be stretched, which may make it difficult to ensure the stability of the cell. For example, in the prior art, side portions of the outer shell 10 may be stretched to excessively reduce its thickness, which may compromise cell stability. In addition, the outer shell 10 manufactured according to the prior art may have a non-uniform thickness depending on its location, which may make it difficult to reconsider the reliability of the insulating and protective performances of the outer shell 10. Furthermore, there may be process limitations that make it difficult for the outer shell 10 to be sufficiently pressed, which means that the space in which the electrode assembly 5 can be accommodated is difficult to expand beyond a certain level. Ultimately, when a conventional forming process for the outer shell 10 is utilized, it may be difficult to accommodate a sufficient amount of the electrode assembly 5 so that a sufficient energy density of the cell can be achieved.

However, according to an exemplary manufacturing method, stretching of the outer shell 10 may be minimized. In order to form the space 14 by forming the outer shell 10 according to an embodiment, a process of pulling a portion of the outer shell 10 may be utilized, in which case the risk of over-pushing one side of the outer shell 10 may be substantially eliminated. In other words, according to an embodiment, the stability of the cell may be secured, and ultimately the lithium secondary battery 1 may be manufactured to have a high energy density.

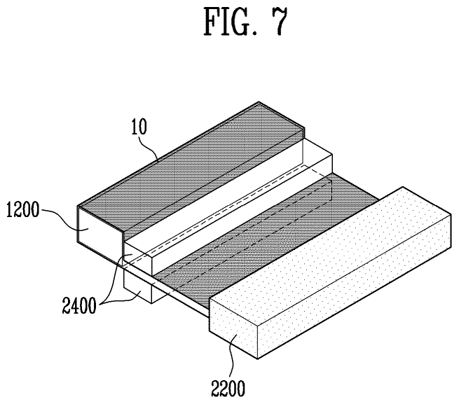

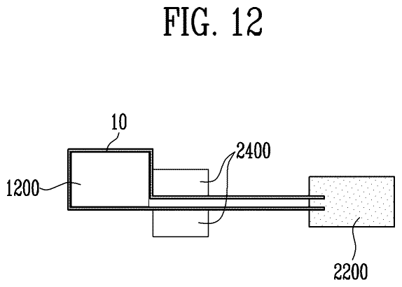

Referring to FIGS. 7 and 12, a first forming portion 2400 may form the outer shell 10 between the electrode assembly mold 1200 and the pulling unit 2200.

According to an embodiment, the first forming portion 2400 may be plural and configured to push on each of a one side and a second side of the outer shell 10 between the electrode assembly mold 1200 and the pulling unit 2200. The first forming portion 2400 may have a rigidity suitable for pushing the outer shell 10, and the shape and properties of the first forming portion 2400 are not particularly limited.

In this step, the first forming portion 2400 may push a region directly adjacent to the electrode assembly mold 1200, such that a side adjacent to the pulling unit 2200 of the electrode assembly mold 1200 may be adjacent to and enclose the electrode assembly mold 1200.

In this step, the first forming portion 2400 may simultaneously push one side and the other side of the outer shell 10, such that there may be no process risk due to the outer shell 10 being pushed.

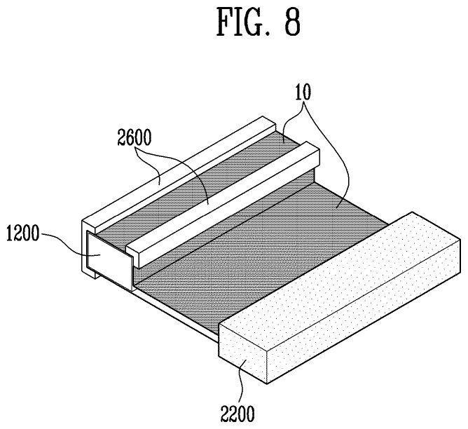

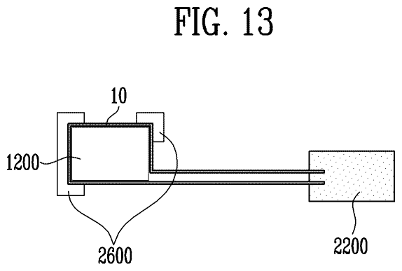

Referring to FIGS. 8 and 13, the second forming portion 2600 may form the edges of the outer shell 10 adjacent to the electrode assembly mold 1200.

According to an embodiment, the second forming portion 2600 may be configured to have a plurality of forming portions to push on the outer shell 10 to form corner regions adjacent to the electrode assembly mold 1200. The second forming portion 2600 may have a rigidity suitable for pushing the outer shell 10, and the shape and properties of the second forming portion 2600 are not particularly limiting.

In this step, the second forming portion 2600 may push against corner regions of the outer shell 10, thereby defining the space 14 enclosed by the outer shell 10 to further correspond to the shape of the electrode assembly mold 1200. Depending on the embodiment, the second forming portion 2600 may push on all four corner regions of the outer shell 10.

In this step, the second forming portion 2600 may push a portion of the outer shell 10 with the electrode assembly mold 1200 supporting the lower portion, such that no process risk is created by the outer shell 10 being pushed.

It should be appreciated that the preceding and following relationship between the first forming portion 2400 forming the outer shell 10 and the second forming portion 2600 forming the outer shell 10 is not particularly limited. For example, the step of forming the outer shell 10 using the first forming portion 2400 may be performed prior to the step of forming the outer shell 10 using the second forming portion 2600, and in some embodiments, the step of forming the outer shell 10 using the second forming portion 2600 may be performed prior to the step of forming the outer shell 10 using the first forming portion 2400.

Referring to FIGS. 9, 14, and 16, the electrode assembly mold 1200 within the formed outer shell 10 may be removed to accommodate the electrode assembly 5.

In this step, the electrode assembly mold 1200 may be removed to form a space 14 having substantially the same size as the electrode assembly mold 1200.

Prior to this step, the electrode assembly 5 including the positive electrode, negative electrode, and separator may be manufactured. For example, a jelly-roll type electrode assembly 5 may be prepared. Then, the electrode assembly 5 may be accommodated in the outer shell 10 and provided in the space 14. As described above, the space 14 is determined based on the electrode assembly mold 1200 having substantially the same size as the electrode assembly 5, and the outer shell 10 can enclose the space 14 to suit the size, e.g., thickness of the electrode assembly 5.

Referring to FIG. 17, a pouch sealing portion 12 can be formed on the outer shell 10. For example, a positive tab 120 and a negative tab 140 connected to the electrode assembly 5 can be disposed, and to form the pouch sealing portion 12, a first pouch film 11a and a second pouch film 11b can be thermally fused along the sealing region 12′. According to an embodiment, an electrolyte solution may be injected into the outer shell 10 prior to forming the pouch sealing portion 12. The sealing region 12′ for forming the pouch sealing portion 12 may be formed along an edge region of the first pouch film 11a and the second pouch film 11b.

According to an embodiment, each of the first pouch film 11a and the second pouch film 11b may include a polyolefin-based resin, e.g., a polypropylene-based resin that can serve as a sealing material. When the first pouch film 11a and the second pouch film 11b are heat pressed against each other, the polyolefin-based resin may melt and seal the outer shell 10.

Depending on the embodiment, if the thickness of the electrode assembly 5 is increased, or if the region of a portion of each of the first pouch film 11a and the second pouch film 11b disposed along the sealing region 12′ is somewhat larger, the sealing region 12′ can be appropriately altered to suitably manufacture the pouch sealing portion 12. For example, if the first pouch film 11a is manufactured with a somewhat longer perimeter length, the sealing region 12′ may be defined to be slightly more adjacent to an edge, e.g., a tip of the outer shell 10. As another example, as the thickness of the electrode assembly 5 increases, the sealing region 12′ may be defined to be slightly more adjacent to the edge, e.g., end of the outer shell 10. Accordingly, the pouch sealing portion 12 may suitably seal a region within the outer shell 10.

1. A method for manufacturing an outer shell for a lithium secondary battery comprising:
(a) a step of preparing an electrode assembly mold and the outer shell;
(b) a step of wrapping the electrode assembly mold with the outer shell and grapping a portion of the outer shell; and
(c) a step of pulling a part of the outer shell grabbed in the step (b) and adjoining the electrode assembly mold and the outer shell.

2. The method according to claim 1, wherein a shape of the electrode assembly mold corresponds to a shape of the electrode assembly to be accommodated in the outer shell.

3. The method according to claim 1, wherein a thickness of the electrode assembly mold corresponds to a thickness of the electrode assembly to be accommodated in the outer shell.

4. The method according to claim 1, wherein the step (b) includes a step of exposing both ends of the electrode assembly mold and a step of surrounding the outer surface of the electrode assembly mold by the outer shell.

5. The method according to claim 1, wherein the step (c) includes a step of contacting the outer shell into with the electrode assembly mold so that the region surrounded by the outer shell has the same shape as the electrode assembly mold.

6. The method according to claim 1, wherein the step (c) includes a step of deforming the shape of the outer shell without pushing one side of the outer shell.

7. The method according to claim 1, wherein the step (c) further includes a step of forming each edge of the outer shell adjacent to the electrode assembly mold in the step (c).

8. The method according to claim 1, further comprising: a step of forming a part of the outer shell between a pulling unit for pulling a part of the outer shell and the electrode assembly mold.

9-12. (canceled)

13. A device for manufacturing an outer shell for a lithium secondary battery comprising:
an electrode assembly mold having the same shape as an electrode assembly; and
a pulling unit disposed on one side of the electrode assembly mold, grapping an end of a pouch-shaped outer shell for accommodating the electrode assembly, and pulling the end of the pouch-shaped outer shell.

14. The device according to claim 13, further comprising: a forming portion to push at least a part of the pouch-shaped outer shell.

15. The device according to claim 13, wherein a thickness of the electrode assembly mold is substantially the same as a thickness of the electrode assembly to be accommodated in the outer shell, and
wherein a shape of the electrode assembly mold is substantially the same as a shape of the electrode assembly to be accommodated in the outer shell.

16. A lithium secondary battery, comprising:
an outer shell; and
an electrode assembly accommodated in the outer shell and including an electrode cell including a positive electrode, a negative electrode, and a separator;
wherein the outer shell includes an upper surface, a lower surface, and a side surface, and
wherein a thickness of the outer shell on the side surface is 0.8 times or more and 1.0 times or less than a thickness of the outer shell on the upper surface.

17. The lithium secondary battery according to claim 16, further comprising: a positive tab electrically connected to the positive electrode, and a negative tab electrically connected to the negative electrode,
wherein the outer shell includes a pouch sealing portion,
wherein the pouch sealing portion includes side sealing portions arranged adjacent to the positive tab or the negative tab and a body sealing portion arranged between the side sealing portions, and
wherein the side surface includes a one side surface adjacent to the body sealing portion and a second side surface adjacent to the side sealing portions.

18. The lithium secondary battery according to claim 16, wherein the thickness of the outer shell on the side surface is 0.9 times or more and 1.0 times or less than the thickness of the outer shell on the upper surface.
